(19) United States
(12) Patent Application Publication
(10) Pub. No.: US 2025/0033083 A1
(43) Pub. Date: Jan. 30, 2025

(54) A DECORATIVE SHEET AND METHOD FOR MANUFACTURING

(71) Applicant: Chiyoda Europa, Genk (BE)

(72) Inventor: Stefan Symkens, Genk (BE)

(73) Assignee: Chiyoda Europa, Genk (BE)

(21) Appl. No.: 18/715,288

(22) PCT Filed: Dec. 2, 2022
(86) PCT No.: PCT/EP22/84187

§ 371 Date: May 31, 2024

(30) Foreign Application Priority Data
Dec. 6, 2021 (EP) 21212520.7

(51) Int. Cl. B05D 3/06; B44C 5/04

(52) U.S. Cl. CPC B05D 3/067; B44C 5/0453; B05D 2203/22

(57) ABSTRACT

A decorative sheet includes: an at least partially UV or visible light irradiation transparent carrier sheet; a decorative ink pattern, the ink being at least partially UV or visible light irradiation blocking; a top coating comprising UV or visible light irradiation curable material and having a top surface with first surface areas having a surface texture A and second surface areas having a surface texture B. The surface texture B being different from the surface texture A and being in alignment with the decorative ink pattern. A decorative panel is also provided that has a substrate and the decorative sheet thereon. A method of manufacturing the decorative sheet is also provided.

### TECHNICAL FIELD

The present invention generally relates to decorative sheets, in particular decorative sheets being used as top layer of decorative panels, such as flooring panels, laminates, furniture panels, wall panels, worktops, cast panels etc.

In addition, the present invention relates to a method for manufacturing such decorative sheets and panels.

### BACKGROUND

Decorative panels, such as flooring panels, laminates, furniture panels, wall panels, etc. coated with simulated versions of materials such as wood and natural stone are commonly used today, in particular where a less expensive material is desired. Obviously, these panels have to be sufficiently resistant against abrasion, indentation, chemicals and moisture.

Such decorative panels substantially consist of a substrate such as MDF or HDF (Medium or High Density Fiberboard) or particle board and a decorative sheet provided thereon. The decorative sheets bear a printed decorative motif or pattern representing the image of different kinds of wood or natural stone such as marble or granite, and one or more finishing layers (so called top coating) to protect the decorative motif.

Typically, top coatings are provided with a structure (i.e. a surface texture, profile, or topography) which gives the panel particular aesthetic and haptic characteristics making the decorative panel more realistic. For example, document WO2004/042168 discloses providing structure in the substrate itself or in a priming layer and to perform a print in the form of a motif on this structured substrate. WO01/48333 provides impressions by a mold or cylinder, in a lacquer layer provided above the motif. WO01/47724 discloses providing a transparent lacquer pattern of structures by means of an inkjet on the motif.

As stated in EP3640042, it is difficult to obtain with the above technique a surface structure corresponding to the decorative motif and at the same time fully protect the decorative motif.

In an attempt to solve this problem, EP3640042 discloses a method for manufacturing coated panels having a substrate and a top layer with a decorative motif where the motif is protected by a synthetic material layer, i.e. a top coating, bearing a surface texture determined by a print, preferably printed by the same printing technique as the print of the decorative motif. The document discloses several methods for obtaining said texture in the synthetic material layer, one of which is using a printed mask. Synthetic material not covered by the mask may be then be cured.

However, there still remains the problem of two printing steps, one for the decorative motif and one for the printed mask, which have to be perfectly aligned in order to get a texture that is perfectly aligned (so-called “in register”) with the decorative motif. Several reasons, amongst others shrinkage and expansion of the substrate make that alignment is attained by continuously steering the register, which still result in alignment problems leading to non-ideal aesthetics, where the deviation in alignment will be visible to the naked eye of someone trained and experienced.

Further, state of the art decorative panels bear top coatings with a mix of different textures, typically a predominant texture and a second distinct texture selectively interrupting or alternating with the predominant texture and corresponding to the decorative motif.

For example, US 2003138617 aims for selective texturing and providing different textures in register with a decorative motif by the following technique: selectivity embossed surface coverings are prepared by mechanically embossing a wear layer which overlays at least one printing ink containing a photoinitiator which has been printed in a pattern or design. The embossed wear layer is subjected to ultraviolet radiation which causes curing of the wear layer in the surface areas disposed over the printing ink. The product then is fused whereby the mechanical embossing in surface areas which are not disposed over the printing ink relaxes and becomes smooth. In a variant of the invention, a thermoplastic wear layer is employed which can be mechanically embossed in the surface areas which are not disposed over the printing ink with a texture different from the first applied mechanical embossing.

Person skilled in the art appreciates the above technique is complex, inefficient, costly, and limits the number texture combinations.

Considering the above, it is a general objective of the present invention to provide a decorative sheet with enhanced aesthetic and haptic characteristics making the decorative panel more realistic than the state of the art.

In particular, it is an objective of the present invention to provide a decorative sheet where surface areas with a texture corresponding to the decorative motif are substantially everywhere in register with the decorative motif. More specifically, it is an objective to obtain top coatings with a predominant texture and a second texture—which is distinctly different to the first texture—selectively alternating with the predominant texture, i.e. interrupting the predominant texture, and being everywhere in register with the decorative motif.

Further, it is an objective of the present invention to provide a decorative sheet which is ready to be adhered to a substrate for forming a decorative panel without further embossing steps required.

Another object of the present invention, is to provide a decorative sheet and panel which can be manufactured in a less complex and/or more efficient and/or less costly manner.

It also a general objective of present invention to provide a method allowing manufacturing a decorative sheet with complex texturing in alignment (i.e. in register) with a complex decorative motif in a less complex and/or more efficient and/or less costly manner.

In addition, it is an objective of the present invention to provide a method allowing manufacturing a decorative sheet combining high coating weights and textures aligned with the decorative motif. High coating weights are typically required to achieve high performance in combination with good aesthetics.

Is also an objective of the present invention to provide a method for manufacturing a decorative sheet achieving selective texture alignment with the decorative motif even when the processes of printing and coating are not done inline such that for example any shrinkage and/or expansion of the decorative sheet during the process does not influence the alignment.

A further objective is to provide a method for manufacturing a decorative sheet achieving selective texture alignment with the decorative motif while allowing the use of digital as well as analogue printing and coating techniques.

In addition, an objective is also to provide a manufacturing method with lower processing complexity and more freedom in material choice.

### SUMMARY

In a first aspect, the present invention provides a decorative sheet comprising:
an at least partially UV or visible light irradiation transparent carrier sheet
a decorative ink pattern, said ink being at least partially UV or visible light irradiation blocking,
a top coating comprising UV or visible light irradiation cured material and having a top surface comprising first surface areas having a surface texture A and second surface areas having a surface texture B, said surface texture B being different from the surface texture A and being in alignment with the decorative ink pattern,
   wherein the decorative ink pattern is characterized by at least partially blocking a first wavelength range of the UV or visible light irradiation, said first wavelength range overlapping with a second wavelength range of the UV or visible light irradiation the carrier sheet is transparent for, and wherein the UV or visible light cured material in the top coating is characterized by a curing wavelength range included in the overlapping wavelength range.

According to the present invention, the decorative sheet is characterized by being less blocking for the overlapping wavelength range at the first surface areas having surface texture A than at the second surface areas having surface structure B.

Further, the present invention provides a decorative panel comprising a substrate and a decorative top layer consisting of a decorative sheet as described throughout this text.

In a second aspect, the present invention provides a method of manufacturing a decorative sheet having a textured surface comprising the steps of:
Providing an at least partially UV or visible light irradiation transparent carrier sheet
Printing a decorative ink pattern on at least part of the upper and/or rear side of the carrier sheet, said ink being at least partially UV or visible light irradiation blocking in a first wavelength range overlapping with a second wavelength range of the UV or visible light irradiation the carrier sheet is transparent for,
providing a UV or visible light irradiation curable coating on the upper side of the carrier sheet, said curable coating suitable for being cured by a curing wavelength range included in the overlapping wavelength range,
selectively curing the UV or visible light irradiation curable coating by exposing it to UV or visible light irradiation including the overlapping wavelength range through the rear side of the carrier sheet and through the decorative ink pattern, thereby curing the first surface areas more than the second surface areas such that the first surface areas result in surface texture A and the second surface areas result in surface texture B.

A method for manufacturing a decorative panel comprising the step of manufacturing a decorative layer using the above method and adhering said decorative layer as a decorative top layer to a substrate is provided as well.

### BRIEF DESCRIPTION OF DRAWINGS:

FIGS. 1, 2 and 3 schematically illustrate an embodiment of a decorative sheet in accordance with the present invention.

FIGS. 4 and 5 schematically illustrate an embodiment of a method for manufacturing a decorative sheet in accordance with the present invention.

FIGS. 6 and 7 schematically illustrate examples of non-alignment of the surface area of texture B with the ink pattern, seen in processes where register is not inherent and continual steering of the register is required.

### DETAILED DESCRIPTION

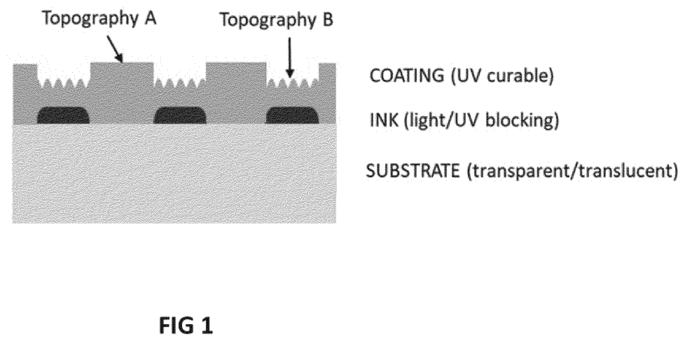

In a first aspect and as illustrated in FIG. 1, the present invention provides a decorative sheet comprising:
an at least partially UV or visible light irradiation transparent carrier sheet
a decorative ink pattern, said ink being at least partially UV or visible light irradiation blocking,
a top coating comprising UV or visible light irradiation cured material and having a top surface comprising first surface areas having a surface texture A (topography A) and second surface areas having a surface texture B (topography B), said surface texture B being different from the surface texture A and being in alignment with the decorative ink pattern, wherein a first wavelength range of the UV or visible light irradiation being at least partially blocked by the decorative ink pattern overlaps with a second wavelength range of the UV or visible light irradiation the carrier sheet is transparent for, and wherein the overlapping wavelength range includes a curing wavelength range suitable for curing the UV or visible light cured material in the top coating.

It is understood that in such decorative sheet, the different layers have the following characteristics:
the decorative ink pattern is characterized by at least partially blocking the first wavelength range of the UV or visible light irradiation which overlaps with the second wavelength range of the UV or visible light irradiation,
the carrier sheet is transparent for the second wavelength range of the UV or visible light irradiation which overlaps with the first wavelength range the decorative ink pattern is at least partially blocking for.
the UV or visible light cured material in the top coating is characterized by having a curing wavelength range within the overlap of the first with the second wavelength range.

In the context of the present invention, at least partially UV or visible light irradiation transparent means being transparent for at least part of the UV or visible light irradiation spectrum, i.e. 100 nm to 780 nm, preferably at least part of the UV spectrum between 150 nm and 450 nm and most preferably between 300 nm and 450 nm.

In the context of the present invention, at least partially UV or visible light irradiation blocking means being able to block irradiation from at least part of the UV or visible light irradiation spectrum, i.e. 100 nm to 780 nm, preferably at least part of the UV spectrum between 150 nm and 450 nm and most preferably between 300 nm and 450 nm.

In the context of the present invention, UV or visible light irradiation cured or curable means cured or curable by being exposed to irradiation from at least part of the UV or visible light irradiation spectrum, i.e. 100 nm to 780 nm, preferably at least part of the UV spectrum between 150 nm and 450 nm and most preferably between 170 nm and 450 nm

Person skilled in the art appreciates that the UV or visible light transparent carrier sheet is not necessarily required to be (partially) transparent for the same wavelength range (i.e. the second wavelength range) as the wavelength range blocked, or partially blocked, by the UV or visible light blocking decorative ink pattern (i.e. the first wavelength range). It however does require that at least part of these first and second wavelength ranges overlap and that the overlapping wavelength range at least partially includes a curing wavelength range suitable for curing the UV or visible light curable material in the top coating. Such overlapping range is, as the skilled person will appreciate, dependent on combination of the carrier sheet and ink, which will be relevant in selection of photoinitiator type of the coating and curing process settings (eg lamp types and irradiation dose).

Further, person skilled in the art appreciates that the first wavelength range, as well as the second wavelength, range may include two or more subranges that are not adjoining. In such case, the overlapping wavelength range may as well include two or more subranges that are not adjoining.

According to the present invention, the decorative sheet is characterized by being less blocking for the overlapping wavelength range at the first surface areas having surface texture A than at the second surface areas having surface structure B.

In an embodiment of the present invention, the UV or visible light transparent carrier sheet may be selected from paper based (impregnated or not impregnated) materials, film, foil or panel based materials, acrylic plastic based materials including PMMA/ABS, thermoplastic based materials including PP, PE, PVC, PET and the like, non-woven based materials, or glass fiber based materials, or any combination thereof.

In an embodiment, the UV or visible light curable material may be any type of known UV or visible light curable coating suitable for finishing decorative sheets or panels. This includes standard light-curing formulations with photoinitiators that are responsible for initiating the polymerization on UV or visible light irradiation, but also other formulations where separate photoinitiators are not required (eg. certain acrylates can initiate polymerization after absorbing light). With regards to UV, a preferred curable material may be radical polymerizable acrylate, polyurethane, epoxy, polyester, ether, unsaturated polyester, or vinyl ether based lacquer, or cationic UV-curable resins. Person skilled in the art will appreciate that a proper combination of photoinitiator type and irradiation wavelength has to be made. The top coating may have a multi-layer build up, applied wet in wet or wet on dry, applied in-line or off-line, wherein at least the top layer comprises the UV and visible light irradiation curable material. Optionally, the UV curable coating may be a dual-cure curing system. This includes a combination of free radical polymerization curing systems (for example including photo-initiators and thermal initiators), and a combination of free radical polymerization curing systems with other types of reactive curing systems (for example isocyanates). Such dual-cure curing system may be beneficial in managing the curl of the decorative sheet.

In an embodiment of the present invention, the curable coating materials may be a mix of components with different curing mechanisms, such as thermally reactive coatings, or reactive poly-urethane based coating combined with UV curable acrylate-based components. In addition, the curable coating materials may comprise non-reactive components as well, such as dissolved acrylics and fillers.

In the context of the present invention, the ink is understood as any product suitable for creating a decorative ink pattern in the application of the present invention. Such ink is a gel, sol, or solution that may contain a colorant, such as a dye or pigment, and is used to apply a pattern to a surface to produce an image, text, or design, visible or not visible to the naked eye. As such, the ink may be a mixture of any of following components, such as, but not limited to solvents, binders, fillers, pigments, dyes and additives. The components may be reactive or non-reactive.

In the context of the present invention, the surface texture of the top coating is the surface structure or structural profile or topography of the surface of the top coating responsible for the haptic characteristics of the decorative sheet. For example, the texture may be smooth (often called “satin finish”) and very soft and subtle and not having a deep grain texture. Another example of texture is “scraped”, i.e similar to real hardwood. Another example is “brushed” i.e. similar to wood being brushed with metal wire, leather or stone (eg slate/granite) or fantasy structures, as functional structures like lotus flower, sharkskin/anti-bacterial and many more. Person skilled in the art appreciates that, in order to achieve both high quality haptic characteristics of the decorative sheet and high quality aesthetic characteristics, both have to match and therefore the surface texture has to be aligned with the decorative motif.

The alignment of the second texture with the decorative ink pattern is (partly) responsible for how the decorative sheet or the product using such sheet as decorative top layer is perceived by customers, for example the perceived authenticity of a wood or stone imitation. Poor alignment leads to a perception of fake and cheap. Alignment of the second texture with the decorative ink pattern can be checked with the naked eye or with one of the following techniques: optical microscopy, UV-Visible-NIR microscopy,

UV-Visible-NIR microspectrometers, spectral surface mapping technology, enabling transmission data to be displayed on a 3D surface map (surface topography+UV-Visible light transmission)

In an embodiment of the present invention, the top surface of the top coating of the decorative sheet comprises first surface areas having a surface texture A and second surface areas having a surface texture B, said surface texture B being different from the surface texture A and being in alignment with the decorative ink pattern. Surface textures A and B may be present adjacent to each other on the top coating surface or may surround each other, depending on the decorative motif the second texture is aligned with.

Typically, the surface texture A is predominant and the surface texture B is alternating with, i.e. regularly or irregularly interrupted by, the predominant texture and aligned with the decorative ink pattern. However, in certain embodiments, the second texture aligned with the decorative ink pattern may cover a higher percentage of the surface area of the top coating than the texture A.

In an embodiment of the present invention, the surface texture A and surface texture B differ from each other in surface roughness and/or in specular reflection or gloss, and/or in top coating thickness, and/or in haptic properties, and/or in surface tension. More specifically, the textures may differ in shallowness or deepness, in higher gloss vs matt surfaces, in the presence of functional features such as light management structures, privacy film, optical gratings, anti-reflection surfaces, holographic surfaces, micro-fluidic devices, antimicrobial surfaces, brand protection, noise-absorbing/reducing, protective coatings. Optionally, one or more of these functional features may be aligned with the decorative motif as well.

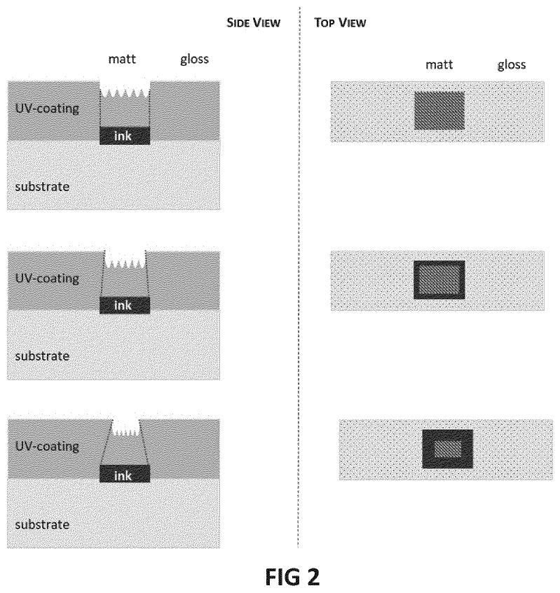

In an embodiment of the present invention, the decorative ink pattern comprises a number of distinct sub-patterns each having a perimeter fully covering the perimeter of the surface area of surface texture B aligned with the corresponding distinct sub-pattern. As shown in FIG. 2, a surface area of surface texture B covers the same or smaller area as the sub-pattern of decorative ink, and is situated directly above the ink, i.e. the area of texture B may be smaller than the area of the corresponding ink sub-pattern due to the wavelike nature of light.

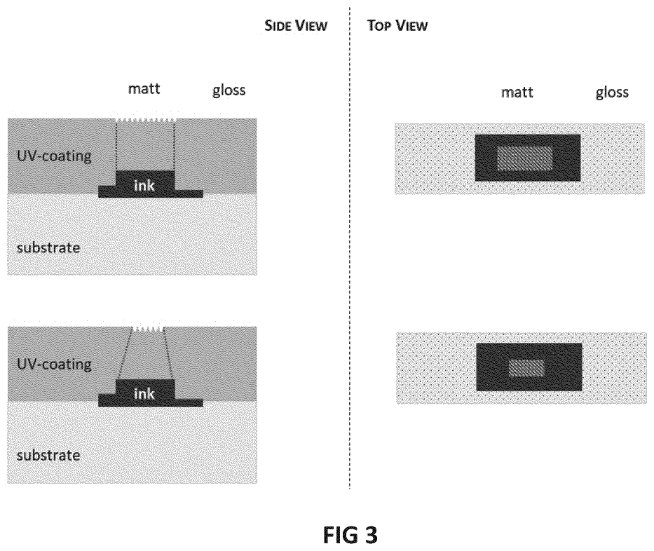

As illustrated in FIG. 3, in an embodiment of the present invention, the decorative sheet does not comprise the second texture in those surface areas where the thickness of the decorative ink pattern present underneath those surface areas is below UV or visible light irradiation blocking threshold thickness. Person skilled in the art will appreciate that this threshold depends amongst others on ink irradiation absorption properties, and ink layer thickness at specific UV process conditions and top-coating formulation. Accordingly, in an embodiment of the present invention, the decorative sheet does not comprise the second texture B in those surface areas where there is no or insufficient decorative ink pattern present underneath those surface areas.

The UV blocking decorative ink pattern may be located between the carrier sheet and the top coating, or it may be located at the rear side of the carrier sheet.

In an embodiment of the present invention, the top coating may have a thickness in areas of surface texture A of at least 4 microns and/or at least 4g/m² of top coating at areas of surface texture A. The top coating may have a thickness of at least 8 microns and/or at least 8g/m² at areas of surface texture A, or at least 15 microns and/or at least 15g/m² at areas of surface texture A, or even at least 30 microns and/or at least 30g/m² at areas of surface texture A.

The decorative sheet of the present invention may be applied as a final product. Final products may be, but not limited to wall paper, packaging or wrapping paper, nonwoven or plastic or glass fiber based fabrics, or any other type of decorative sheet. The decorative sheet may also be a panel. This panel may be glass or polymer based, and may be self-supporting.

Preferably, the decorative sheet of the present invention may be applied as an intermediate product for being adhered as a decorative top layer to any type of substrate for forming a final product. Such final product may be any type of panel such as flooring panels, wall panels, advertising panels, etc, or panels for assembling any type of furniture such as tables, kitchens, office desks, closets and the like. The substrate of any such final product may be wood based, glass based, stone based, carbon based, plastic based, metal based, mineral (eg. Gyproc) based, etc. Specific applications may be wooden plank look-alikes (flooring/sidings/decking/skirting boards/ . . . ), exterior furniture, high level finish foil, technical foil, acrylic décor, release film for texturing other surfaces (including recreational vehicles/caravan applications and textiles in the fashion industry), auto-motive parts for interior and exterior, molded parts or panels in general.

In a second aspect, the present invention provides a method of manufacturing a decorative sheet having a textured surface comprising the steps of:
Providing an at least partially UV or visible light irradiation transparent carrier sheet
Printing a decorative ink pattern on at least part of the upper and/or rear side of the carrier sheet, said ink being at least partially UV or visible light irradiation blocking in a first wavelength range overlapping with a second wavelength range of the UV or visible light irradiation the carrier sheet is transparent for,
providing a UV or visible light irradiation curable coating on the upper side of the carrier sheet, said curable coating suitable for being cured by a curing wavelength range included in the overlapping wavelength range,
selectively curing the UV or visible light irradiation curable coating by exposing it to UV or visible light irradiation including the overlapping wavelength range through the rear side of the carrier sheet and through the decorative ink pattern, thereby curing the first surface areas more than the second surface areas such that the first surface areas result in surface texture A and the second surface areas result in surface texture B.

In contrast with conventional methods where a mask is used on top of the curable coating to selectively solidify it and where the mask is removed afterwards, in the present invention the mask remains in the decorative sheet in its function of being the decorative or functional motif. Therefore, the mask, i.e. in this case the at least partially UV or visible light irradiation blocking decorative ink pattern, has to be printed on the upper or rear side of the carrier sheet, and therefore, in order to selectively expose the curable coating, the carrier sheet has to be, at least partially, transparent to the curing wavelength range to allow exposing the curable coating from the its rear side.

In the method of the present invention, providing the curable coating can be completely disconnected from the printing of the decorative ink pattern, as the decorative print pattern determines its selective curing.

Printing the at least partially UV or visible light irradiation blocking decorative ink pattern may be done by any technique including, but not limited to, analogue printing, rotogravure printing or screen printing, or by digital printing methods as well, such as inkjet printing.

As illustrated in FIG. 3, in an embodiment of the present invention, the decorative ink pattern has to be printed with a thickness of at least the UV or visible light irradiation blocking threshold thickness, such that the decorative ink pattern present has sufficient ink irradiation absorption properties, underneath those surface areas where selective curing of the curable coating is not supposed to happen in order to obtain surface texture B in those surface areas. The blocking threshold thickness with sufficient absorption properties can also be achieved by overlapping of inks in layers of different composition. The blocking threshold thickness where sufficient absorption properties are achieved can vary depending on the absorptive properties of the ink used

It is clear that, at the resulted surface areas having texture A, the absorption (i.e. blocking) by the decorative ink pattern of the UV/visible light through the carrier sheet is always less than the absorption/blocking at the resulted surface areas having texture B.

Coating the upper or rear side of the carrier sheet with the UV or visible light irradiation curable coating may be done by any known coating technique known in the art, such as roll, rotogravure, slotdie, commabar, screen printing, or curtain coating.

The UV or visible light irradiation curable coating may be exposed to a curing wavelength range from at least part of the UV or visible light irradiation spectrum, i.e. 100 nm to 780 nm, preferably at least part of the UV spectrum between 150 nm and 450 nm. The curing is dependent on a combination of a number of variables, including but not limited to substrate (type and/or thickness); coating formulation (photoinitiator type and/or concentration, additives, pigments etc); coating thickness; ink formulation (pigment type and/or concentration); ink thickness; lamp (type, age, dosage); distance between lamp and coating; exposure time (line speed, number of lamps). Further, applying non-uniform UV or visible light irradiation may result in variable surface textures A and variable surface textures B at different selective areas due to the non-uniformity of the irradiation source.

During the curing process of radically radiation curable coatings, the double bond concentration will decrease as the curing increases. This will gradually change the physical and chemical composition of the coating, going from its liquid, uncured stage to its solid full cured stage. Full cured does not mean 0% double bonds, but the curing level of the coating which makes it fit for purpose. As does liquid not always mean a uncured stage, it can also be a stage at which we already have a decrease in the amount of double bonds, but still have a liquid coating, which shows in this case most of the times an increase in viscosity. Likewise, as does solid not always mean a full cured stage, it can also be a stage at where there are still more double bonds present than at the full cured stage. Curing the first surface areas more than the second surface areas means that after exposure to the curing wavelength range, the curing stage of the first surface areas will be closer to full cured stage than the curing stage of the second surface areas, the latter consequently being closer to liquid, uncured stage.

In an embodiment of the present invention, the method further comprises UV-embossing the UV or visible light curable coating. By UV-embossing, surface areas of the coating that were exposed or will be exposed to UV or visible light irradiation through the decorative ink pattern may be given a specific surface texture A, defined by the mould, different from texture B. UV-embossing is done while exposing the coating to UV or visible light irradiation through the decorative ink pattern, while being in contact with the surface of the mould.

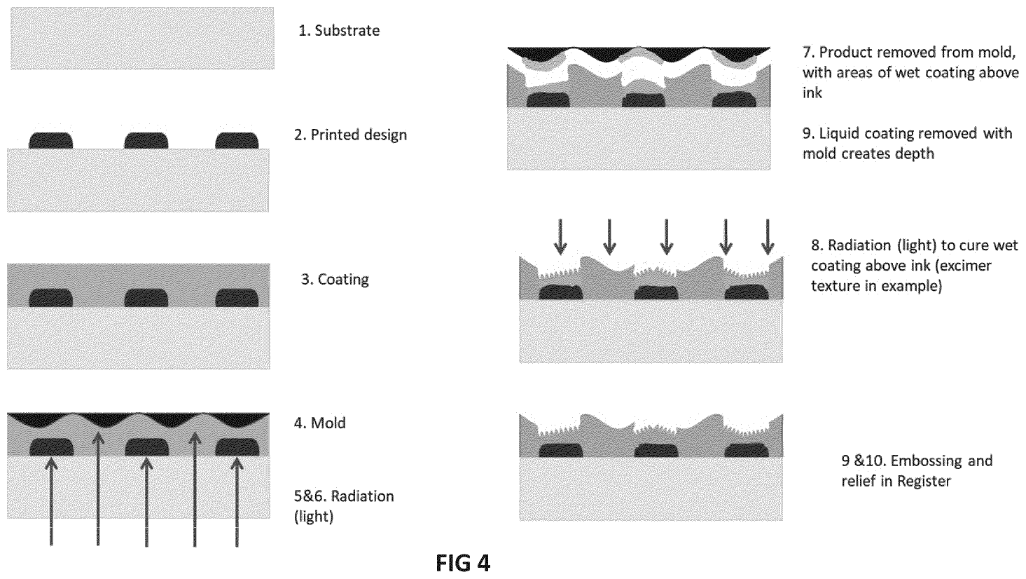

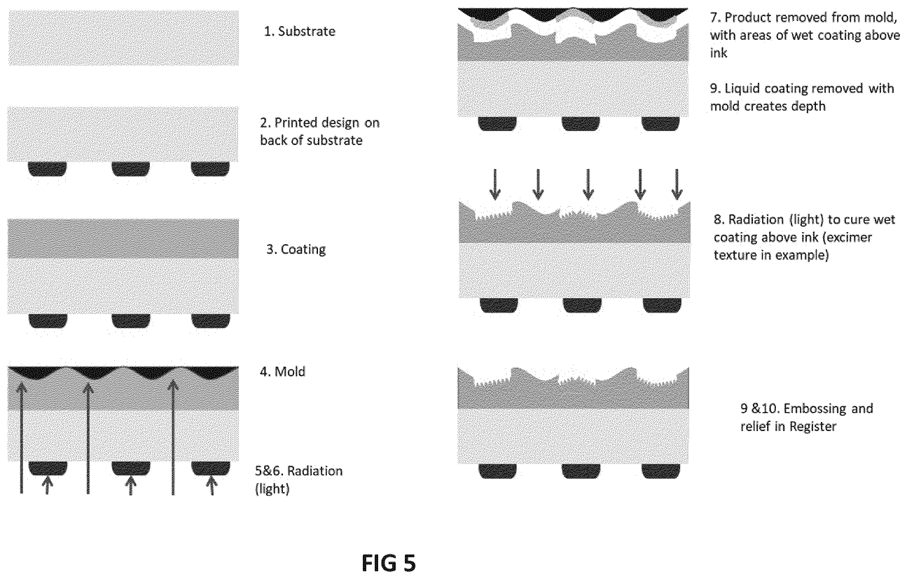

FIG. 4 and FIG. 5 illustrate preferred embodiments of a method according to the present invention. In FIG. 4, the decorative ink pattern is printed on at least part of the upper side of the carrier sheet (step 2), while in FIG. 5 it is printed on at least part of the rear side the carrier sheet (step 2). Then a UV or visible light irradiation curable coating is applied (step 3). In these preferred embodiments, embossing comprises positioning a mold over the UV or visible light irradiation curable coating (step 4) and exposing the coating to UV or visible light irradiation through the substrate and the decorative ink pattern while still being in contact with the mold thereby partially curing the UV or visible light irradiation curable coating (step 5&6), and consequently separating the decorative sheet and the mold (step 7). While being in contact with the mold the curable coating is sufficiently irradiated to selectively solidify. In the areas where the UV or visible light blocking decorative ink pattern is sufficiently present, the curable coating will remain in less cured stage due to lack of sufficient radiation to solidify. Upon removal of the decorative sheet from the mold, less cured, still liquid coating will remain partly in the mold (step 9), resulting in a reduced amount of curable coating in the surface areas where a surface texture B is to be obtained.

In a further preferred embodiment, the method further comprises a second curing step for curing the less cured curable coating (step 8), thereby achieving the surface texture B. This second curing may be done by exposure to a wavelength range in at least part of the UV/visible spectrum between 100 nm and 450 nm, and most preferably in at least part of the UV irradiation spectrum suitable for being generated by an excimer irradiation source, followed by a third radiation (UV/VIS-light or EB) curing step to completely solidify the coating. Exposure to UV irradiation may also by combined with a thermal cure, in order to create a specific surface texture B. This second curing step enables to create different gloss-levels and structures at the surface areas where the liquid coating was situated compared to the coating areas which were already cured against the mold. The surface structure of the coating cured in the mold will be a cast of the structure present in the mold and will no longer be affected by any of the structure defining techniques present during the second curing process where texture B is separately fixed in subsequent steps. The second curing step can also further cure the coating at surface areas A, as they do not need to be at their full cured stage when removing them from the mold. It is also possible to bring the coating to its full cured stage by means of EB-curing and/or thermal curing, with or without a combination of those with UV-curing. This second curing step can comprise more than 1 processing step, combining any of the above curing mechanisms

The method of the present invention enables to create surface areas, in register with the decorative motif with less coating weight which create a wanted relief being the valleys (texture B) matching the blocking printing ink pattern and the other surface areas matching the structure of the mold (texture A).

Types of molds that may be used include (but are not limited to) structured paper/film, embossed plates/panels and embossing cylinders.

The methods of the present invention enable to create a printed, coated and embossed decorative sheet which is perfectly in register by its very nature, in a less complex, more efficient and more cost-effective manner. In addition, these methods allow application in a roll-to-roll process, as well as a sheet process.

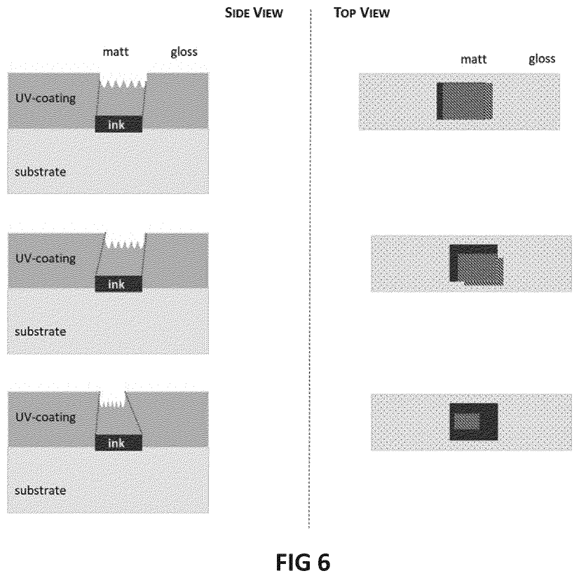

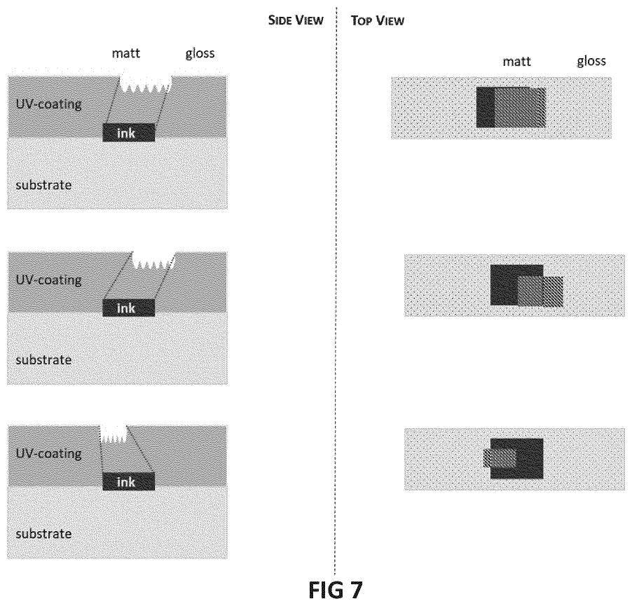

In FIGS. 6 and 7, some examples of non-alignment of the surface area of texture B with the ink pattern, seen in processes where register is not inherent and continual steering of the register is required.

Surface areas resulted in texture A are different from surface areas resulted in texture B in appearance, structure, topography, haptic effect, or gloss. This difference is obtained by the difference of the curing level of the top coating at the first surface areas vs second surface areas in the initial/first irradiation of the coating surface by a UV/visible light source. This light source can be uniformly applied over the complete printed substrate, first passing through the UV-blocking ink before reaching the

UV/visible light curable coating. Once the initial curing step is performed, the difference in surface properties between first surface areas and second surface areas are always related to the different behavior of the coating due to the difference of radiation dose it is irradiated with in this first curing step at the first surface areas and second surface areas.

At the surface area B, the coating can still be close to original coating viscosity, after this first curing step, making it easy to be removed by washing and vacuum techniques. Also even if the first surface areas remain close to original coating viscosity after the first curing step, however a bit more cured than the second surface areas, different surface textures A and B can be created with subsequent curing steps, for example with UV-excimer.

Even in case the radiation curable coating is already solidified over the complete surface of the coating after the first curing step, due to the lower radiation dose at the second surface areas B, the mechanical and/or chemical resistances of the coating at these second surface areas will be lower compared to first surface areas A. As a consequence the coating at surface area B will be more easily removed by mechanical (brushed) or chemical (etching) ways, thus creating difference in surface appearance and amount of coating remaining on the substrate.

In an embodiment of the method in accordance with the present invention, the UV or visible light transparent carrier sheet may be selected from paper based (impregnated or not impregnated) materials, film or foil based materials, acrylic plastic based materials including PMMA/ABS, thermoplastic based materials including PP, PE, PVC, PET and the like, non-woven based materials, or glass fiber based materials, or any combination thereof. As a person skilled in the art will appreciate, the preference depends strongly on the pigmentation, and other UV/light absorbing substance used in the different substrates. For example, a white substrate containing TiO2 pigment will absorb a large portion of the UV-light and will therefore be more likely to be used in combination with a coating containing photo-initiators which are activated by light in the visible range.

A method of the present invention may additionally comprise adding an opaque layer to the rear of the decorative sheet after the first curing step or after the second curing step. This opaque layer can be applied by a printing or coating process or during the lamination or pressing process.

Further, it may be desirable to protect surface textures A or B or both in further downstream processing steps. This can be done by coating the surface areas, thereby forming a decorative sheet bearing a removable protective layer protecting surface textures A and B. The protective layer can be removed after subsequent downstream processing steps, e.g. after the pressing stage. In general, protecting surface textures A or B or both may be obtained by filling the textures thereby ensuring that any depth created in the textures is maintained (and not flattened) in downstream processing, such as pressing. Generally, filling the texture is achieved by applying a liquid release coating which is cured/solidified after application on the textures A and B or by extruding a removable film. More specifically, the following techniques may be applied:
extrusion of a protective polymer layer onto the surface area of the decorative sheet
application of a protective coating that after curing or drying is peelable from the surface area of the decorative sheet;
laminating the surface areas with a polymeric carrier film coated with an UV-curable protective coating
applying a protective coating onto the surface areas and subsequently laminating a polymeric carrier film onto the protective coating

The polymer carrier film acts as a carrier layer for the protective coating enabling application of and/or removal of the protective coating.

Further, after the second curing step, preferably by excimer irradiation, at the second surface areas, deep macro-textures may be pressed into areas A and/or B while maintaining the (micro) surface textures A and B of the decorative sheet. In this case, the curing level attained by UV prior to the press cycle may need to be limited to facilitate this.

A method of the present invention may additionally comprise providing a second UV or visible light irradiation curable coating on the rear side of the carrier sheet. As the UV or visible light irradiation is applied on the rear side of the carrier sheet through the carrier sheet, this second curable coating will be cured and may counter balance for potential curl exhibited by the top coating.

In additional embodiments of the present invention, the method may further comprise additional steps resulting in a variation of decorative sheets or panels relating to the decorative sheet or panel of the present invention, for example:
Overcoating the top coating having surface areas A and B, at selective areas, with any know method and curing mechanism, resulting in selective surface areas not having surface textures A or B anymore.
Applying a first coating layer which is transparent for at least the overlapping wavelength range on the carrier sheet, and subsequently applying the top coating layer at selective areas on the coated substrate and creating surface areas A and B as described throughout this text, in these selective areas, hereby creating a multilayer coated carrier sheet where only in selective areas the surface textures A and B are present.
Repeating the steps of providing a top coating on selective areas of the present top coat with surface areas A and B and irradiating thereby creating new surface areas A and B at these selective coated areas. These second surface areas A and B created at these selective coated areas on top of the first surface areas A and B can differ from the first surface areas A and B depending on which method and/or coating and/or radiation range and/or dose is used as described above.

### EXAMPLE

A paper based carrier sheet, known in the market as overlay with a weight of 28 g/m² (Glatz) is provided. This overlay paper is printed in rotogravure with standard waterbased rotogravure inks (KGE AG) and cylinders as used in decorative printing. Additionally, the thus printed overlay paper is printed in register, in-line, with a carbon black containing waterbased ink for decorative purposes (KGE AG) with a rotation screen printing unit to obtain areas of high UV/visible-light absorption. The print can be done on either side of the overlay, whatever suits the purpose of the final product best. The design can be wood, stone or fantasy. As a next processing step this printed overlay paper is impregnated with waterbased melamine resins (BASF) on a standard impregnation (Vits) line and winded again after drying of the melamine resin, with a resin content of 100-120%, calculated on the paperweight. This printed and impregnated overlay paper is than coated with a solvent based polyurethane primer containing polyols (Desmphen type) 30-70% and isocyanates (desmodur types) 20-60% and 10-50% of radiation curable acrylates. After drying of the primer, the radiation curable top coating is applied with a slot-die application system, applying 30 to 300 g/m2 of an UV-curable resin mixture, comprising 30-70% of an urethane acrylate, (Sartomer) 5-50% of acrylate based monomers (Sartomer), 0,5-3% of photoinitiator (IGM), fillers and matting agents (Grace) 1-25%. This printed, impregnated, primered and coated paper is then irradiated from the rear side, through the substrate, printing inks and coating. An UV-lamp unit of IST with an output of 160 W/cm, having a standard mercury lamp, with at 50% of its power is used at a speed of 25 m/min. At the areas of the screen printed, black ink, the UV/visible light absorption is very high and thus the coating above these areas remains liquid due to lack of radiation dose. At the areas where only rotogravure printed inks are present, sufficient radiation of the UV-lamp will pass through the overlay substrate and ink to solidify the coating, depending on its exact composition, creating a semi-gloss to glossy surface. As second radiation curing step, now applied from the front-side (coated side), the complete surface, with areas of partially still liquid coating, will be irradiated with an UV-excimer lamp at 172 nm, creating a very matt coating surface only at the still liquid coating areas, followed by a final cure with 2 rows of high intensity, microwave induced UV-lamps (Fusion) to fully cure all areas of the coating as fit for purpose. Thus, a coated, translucent printed overlay based intermediate decorative sheet is obtained with very matt coating areas (texture B) above the black screen printed ink and semi-to high gloss coating above the other areas (texture A). This decorative sheet with perfect alignment between the screen printing and matt areas of the coated surface, can now be pressed in DPL, CPL or HPL-presses to obtain the desired panels/laminates with an in-register gloss/matt coated surface. Further texturing can be done by the press-plates during the press-cycle, but and the microstructures created to obtain the gloss/matt effect can be maintained in the press-cycle.

1. A decorative sheet comprising:
an at least partially UV or visible light irradiation transparent carrier sheet-sheet,
a decorative ink pattern, said ink being at least partially UV or visible light irradiation blocking,
a top coating comprising UV or visible light irradiation cured material and having a top surface comprising first surface areas having a surface texture A and second surface areas having a surface texture B, said surface texture B being different from the surface texture A and being in alignment with the decorative ink pattern, and
wherein the decorative ink pattern is characterized by at least partially blocking a first wavelength range of the UV or visible light irradiation, said first wavelength range overlapping with a second wavelength range of the UV or visible light irradiation the carrier sheet is transparent for, and wherein the UV or visible light cured material in the top coating is characterized by a curing wavelength range included in the overlapping wavelength range.

2. The decorative sheet according to claim 1, said decorative sheet characterized by being less blocking for the overlapping wavelength range at the first surface areas having surface texture A than at the second surface areas having surface structure B.

3. The decorative sheet according to claim 1, wherein the second surface areas with surface texture B alternate with the first surface areas with surface texture A.

4. The decorative sheet according to claim 1, wherein the decorative ink pattern is located between the carrier sheet and the top coating.

5. The decorative sheet according to claim 1, wherein the decorative ink pattern is located at the rear side of the carrier sheet.

6. The decorative sheet according to claim 1, wherein the decorative ink pattern comprises a number of distinct sub-patterns each having a perimeter fully covering the perimeter of the surface area of surface texture B aligned with the corresponding distinct sub-pattern.

7. The decorative sheet according to claim 1, wherein the top coating has a thickness of at least 4 microns and/or at least 4 g/m² at areas of surface texture A.

8. The decorative sheet according to claim 7, wherein the top coating has a thickness of at least 30 microns and/or at least 30 g/m² at areas of surface texture A.

9. The decorative sheet according to claim 1, wherein the surface texture A and surface texture B differ from each other in surface roughness and/or in specular reflection or gloss, and/or in top coating thickness, and/or in haptic properties, and/or surface tension characteristics.

10. The decorative sheet according to claim 1 further comprising a removable protective layer protecting surface textures A and B.

11. A decorative panel comprising a substrate and a decorative top layer comprising the decorative sheet according to claim 1.

12. A method of manufacturing a decorative sheet having a textured surface comprising:
providing an at least partially UV or visible light irradiation transparent carrier sheet,
printing a decorative ink pattern on at least part of the upper and/or rear side of the carrier sheet, said ink being at least partially UV or visible light irradiation blocking in a first wavelength range overlapping with a second wavelength range of the UV or visible light irradiation the carrier sheet is transparent for,
providing a UV or visible light irradiation curable coating on the upper side of the carrier sheet, said curable coating suitable for being cured by a curing wavelength range included in the overlapping wavelength range, and
selectively curing the UV or visible light irradiation curable coating by exposing it to UV or visible light irradiation including the overlapping wavelength range through the rear side of the carrier sheet and through the decorative ink pattern, thereby curing the first surface areas more than the second surface areas such that the first surface areas result in surface texture A and the second surface areas result in surface texture B.

13. The method according to claim 12, further comprising positioning a mold over the UV or visible light irradiation curable coating and exposing the coating to UV or visible light irradiation through the decorative ink pattern while still being in contact with the mold thereby selectively curing the UV or visible light irradiation curable coating, and subsequently separating the decorative sheet and the mold.

14. The method according to claim 12, further comprising a second curing step for curing the less cured curable coating of the second surface areas resulting in texture B.

15. The method according to claim 13, wherein in the second curing step the less cured curable coating is exposed to UV irradiation generated by an excimer irradiation source.

16. The method according to claim 13, further comprising providing a removeable protective coating on the surface textures A and B.

17. A method for manufacturing a decorative panel comprising the step of manufacturing a decorative layer using a method according to claim 12, and adhering said decorative layer as a decorative top layer to a substrate.
